(19) United States
(12) Patent Application Publication
(10) Pub. No.: US 2016/0044541 A1
(43) Pub. Date: Feb. 11, 2016

(54) RELAXED PERFORMANCE REQUIREMENTS FOR OFFLOADING MEASUREMENTS

(71) Applicant: NOKIA TECHNOLOGIES OY, Espoo (FI)

(72) Inventors: Petteri LUNDEN, Espoo (FI); Elena VIRTEJ, Espoo (FI); Lars DALSGAARD, Oulu (FI); Jarkko Tuomo KOSKELA, Oulu (FI)

(21) Appl. No.: 14/782,202

(22) PCT Filed: Apr. 7, 2014
(86) PCT No.: PCT/IB2014/001674

§ 371 Date: Oct. 2, 2015

Related U.S. Application Data
(60) Provisional application No. 61/808,721, filed on Apr. 5, 2013.
(60) Provisional application No. 61/937,173, filed on Feb. 7, 2014.

(51) Int. Cl. H04W 28/16; H04W 24/08; H04W 76/04

(52) U.S. Cl. CPC H04W 28/16; H04W 76/048; H04W 24/08

(57) ABSTRACT

Various communication systems may benefit from relaxed performance requirements. For example, long term evolution (LTE), and in particular heterogeneous networks (HetNet) as well as small cell detection and discovery in small cell deployments in general, may benefit from relaxed performance requirements for offloading measurements. A method can include determining whether a user equipment is in active data transfer. The method can also include using a relaxed performance requirement with respect to a plurality of gap bursts when the user equipment is determined not to be in active data transfer.

### CROSS-REFERENCE TO RELATED APPLICATION

The present application is related to and claims the benefit and priority of U.S. Provisional Patent Application No. 61/937,173 filed Feb. 7, 2014, the entirety of which is hereby enclosed herein by reference, and is also related to and claims the benefit and priority of U.S. Provisional Patent Application No. 61/808,721, filed Apr. 5, 2013, the entirety of which is hereby incorporated herein by reference.

### BACKGROUND

1. Field

Various communication systems may benefit from relaxed performance requirements. For example, long term evolution (LTE), and in particular heterogeneous networks (HetNet) as well as small cell detection and discovery in small cell deployments in general, may benefit from relaxed performance requirements for offloading measurements.

2. Description of the Related Art

HetNet implementations may be concerned with efficient inter-frequency small cell discovery, with the intention of detecting offloading opportunities on other carrier frequencies in a way that is energy efficient for one or more user equipment (UE). Furthermore, the third generation partnership project (3GPP) may standardize relaxed UE performance requirements for searching/measuring inter-frequency cells, or small cells, for example when such cells are deployed for offloading purpose. The network (NW) may indicate, on a carrier-by-carrier basis, for which carrier(s) this relaxed performance requirement(s) apply.

Relaxed measurement performance can mean that the UE is given more time for detecting, identifying and measuring cells. Thus, these requirements may be less strict requirements than what is currently available. Such a relaxation in requirements may save UE power, because the UE can or is allowed to measure less frequently.

Indeed, relaxed measurement performance may save much power on the UE side when the UE is searching for inter-frequency cells on another carrier in the background for long periods of time. This may happen, for example, in cases in which the network has deployed hotspot areas of small cells for example for the purpose of increasing the capacity in the network in certain highly loaded areas. The network may not, a priori, know the location of the UE and the UE may not know the location of the deployed small cells. This lack of information may lead to the need for continuous search for these small cells on the other carrier. This constant search can lead to inefficiency on the UE side in terms of power used for unsuccessful searches. On the other hand, infrequent measurements for infrequent cell detection can delay the offloading to the small cell when the UE gets active with data transmission.

The current LTE UE requirements are specified in 3GPP technical specification (TS) 36.133, the entirety of which is hereby incorporated herein by reference. In particular, section 8.1.2.3 explains the relatively strict requirements mentioned above.

### SUMMARY

According to certain embodiments, a method can include determining whether a user equipment is in active data transfer. The method can also include using a relaxed performance requirement with respect to a plurality of gap bursts or set of measurements when the user equipment is determined not to be in active data transfer.

In a variant, the method can include determining that the user equipment is in active data transfer when at least one trigger occurs, selected from an inactivity timer is running; user equipment uplink buffers are not empty or a non-empty buffer status report is or has been sent to network; short discontinuous reception is active; the user equipment has powerPrefIndication set to normal; the UE has sent a scheduling or UL resource request in uplink or received a downlink assignment; the user equipment has on-going or pending re-transmissions; or a user equipment radio resource control release timer not expired.

In a variant, the method can include starting a gap burst of the plurality of gap bursts or measurement set when a discontinuous reception inactivity timer is started or when a buffer status report or scheduling request is triggered.

In a variant, the gap burst can be an additional gap burst or can shift timing of further gap bursts.

According to certain embodiments, a method can include determining whether a user equipment is in active data transfer. The method can also include using a relaxed performance requirement with respect to a plurality of gap bursts or measurements when the user equipment is determined not to be in active data transfer.

According to certain embodiments, a method can include indicating relaxed performance requirements with respect to a plurality of gap bursts or measurements. The method can also include configuring the plurality of gap bursts.

In a variant, the configuring the plurality of gap bursts comprises configuring a pattern of the gap bursts.

In a variant, the indicating the relaxed performance requirements comprises indicating the relaxed performance requirements for a particular cell or carrier.

Apparatuses, in certain embodiments, can include means for performing the above described methods in all or any of their variants.

Apparatuses, in certain embodiments, can include at least one processor and at least one memory including computer program code. The at least one memory and the computer program code can be configured to, with at least one processor, cause the apparatuses at least to perform the methods described above in any or all of their variants.

A non-transitory computer readable medium can be encoded with instructions that, when executed in hardware, perform a process. The process can include the methods described above in any or all of their variants.

A computer program product can encode instructions for performing a process. The process can include the methods described above in any or all of their variants.

### BRIEF DESCRIPTION OF THE DRAWINGS

For proper understanding of the invention, reference should be made to the accompanying drawings, wherein:

FIG. 1 illustrates a simplified flow diagram of a method according to certain embodiments.

FIG. 2 illustrates a flow chart according to method according to certain embodiments.

FIG. 3 illustrates gap usage according to certain embodiments.

FIG. 4 illustrates a system according to certain embodiments.

### DETAILED DESCRIPTION

In certain embodiments, a user equipment (UE) can apply a relaxed measurement performance requirement only when the UE is not in an active data exchange with the network. For example, the UE can apply the relaxed measurement performance requirement only when the UE is not receiving or sending any data. Otherwise, for example when the UE is in active data exchange with the network, the UE can apply normal measurement performance requirement according to 3GPP TS 36.133 or similar strict specifications.

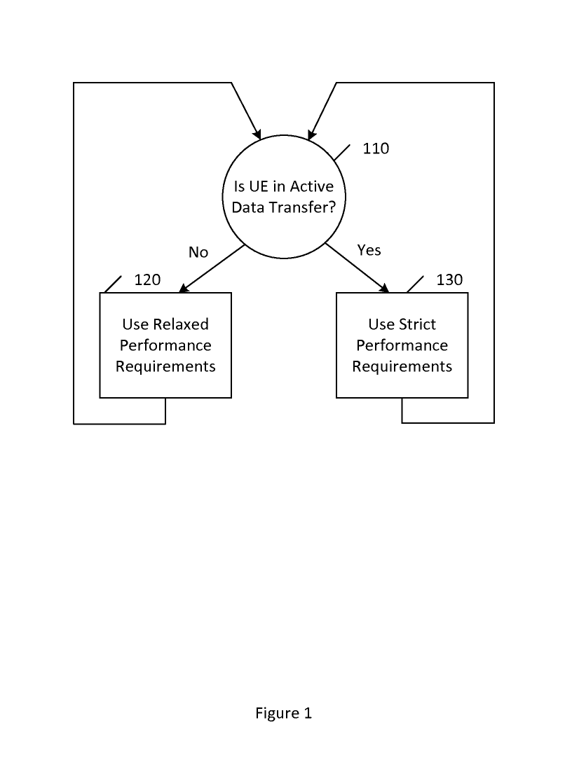

FIG. 1 illustrates a simplified flow diagram of a method according to certain embodiments. As shown in FIG. 1, the method can include, at 110, determining whether a UE is in an active data transfer. If not, then at 120 the method can include the UE using relaxed performance requirements, particularly, for example, with respect to the use of bursts of gaps for example repeated with some longer repetition period, or in general for initiating a set of measurements. On the other hand, if it is determined at 110 that the UE is in active data transfer, then at 130 the method can include the UE using strict performance requirements.

The determination of whether the UE is an active data exchange, or transmitting/receiving data, can be made in many ways. The following are a few examples of the ways such a determination can be made. The determination can be based on whether an inactivity timer is running, which can be the timer that is started when the UE is scheduled. Alternatively, the determination can be made based on the current value of the timer. In general it could be determined based on the status of a timer used or started in connection with a data exchange (UL and/or DL) between UE and network for example a timer which is (re-)started when UE is allocated or receiving a UL and/or DL allocation.

In another option, the determination can be made based on whether the UE uplink (UL) buffers are not empty or a non-empty buffer status report (BSR) is to be or has been sent to the network. Another option is that determination can be made based on whether discontinuous reception (DRX) is configured and short DRX is active. For example, the UE may be configured with DRX where the DRX scheme or configuration includes a shorter DRX periodicity used in a given time following a data exchange between UE and network.

In case of a UE capable of providing power preference indication, the determination can be made based on when the UE has the powerPrefIndication set to normal, having T340 with the timer value set to the powerPrefIndicationTimer running, either started or restarted. Such power preference indication could be used for example by the UE to indicate to the network that the UE would prefer to use power saving and would for example not have any data for transmission.

In other options, the determination can be based on whether the UE has sent a scheduling request (SR) or Random Access burst in UL or got a downlink (DL) assignment. Thus, the basis for the determination can be whether the UE is scheduled. In another option the determination can be based on whether the UE has on-going re-transmissions for example pending HARQ re-transmissions in uplink and/or downlink. Furthermore, in other options, the determination can be based on other timers are running, such as T310, T311, T301, and the like. For example, T310 can indicate that there is a physical (PHY) layer related problem, and T311 and T301 can indicate that RRC connection re-establishment is on-going or requested. The determination can also be based on whether a UE radio resource control (RRC) release timer not expired.

The determination can be based on more complex mechanisms, such as multiple triggers to start inactivity timers, which may be indication of “transmitting data.” For example, any combination of the above examples can be used.

Additional or alternative approaches can be used, for example, for a bursty gap pattern. The UE can start a gap burst, or measurement burst, or a set of measurements potentially performed without gap-assistance, when the DRX inactivity timer is started, in the case of DL activity, or when BSR/SR is triggered with respect to UL activity or in general when data activity or data transmission in UL and/or DL is initiated. This may be an additional gap burst that does not affect the gap pattern otherwise, or it may also shift the timing of further gap bursts, for example by effectively re-aligning the gap pattern. Other conditions for UE becoming active could be used as well. For example, something can be used as a basis, which doesn't trigger based on a single scheduling, but only when there is more data, for example, the UE is on active time for longer than X ms, or an inactivity timer is (re-) started N times without expiring first, for example if such timer is re-started each time an UL/DL allocation is received/scheduled, or the data amount to be exchanged is larger than a given size (for example based on UE and/or network buffer size information). This delayed triggering can reduce the amount of measurements by UE, while introducing more delay.

The approaches outlined above can be realized in different ways in practice and can be specified in different ways of standards. The following example is one non-limiting example. The following description uses gap assisted measurements for illustrating the principle of the method of certain embodiments, but it should be observed that same principles apply also for non-gap-assisted measurement for example measurements performed with second receiver without need for measurement gaps.

Every time data transmission is initiated, the UE can perform measurements using enough available gaps, as currently specified or alternatively new gaps or gap pattern or similar. The amount of gaps or measurement time may be defined as enough by a standard agreement. The UE can be configured with relaxed requirements. In case there are no data transmissions, the UE may only need to perform search/measurement according to relaxed requirements. Relaxed requirements can be tightened as a function of whether active data transmission happens or is initiated. Alternatively the potential start of data transmission could be predicted and aligned with the on-duration of a configured DRX configuration. For example, the measurement could be done at each on-duration or for a given repetition of on-duration, for example every 5^{th} on-duration.

As an example, the UE in connected mode may perform cell detection and measurement according to relaxed requirements if the UE is not actively transmitting and/or receiving data. If the UE is actively transmitting and/or receiving data, the UE may instead perform cell detection and measurements according to existing requirements, or according to tighter requirements than the relaxed requirements.

For example, a UE may be in connected mode, configured with DRX and actively applying DRX. Thus, the UE may not be in active data exchange with another entity. In such a case, the UE may perform cell detection according to relaxed requirements. For example, the UE may wake up for each on-duration but only perform the measurements on the indicated carrier every Xth time the UE wakes up. In case the UE is scheduled during the on-duration the UE can perform additional measurements besides those performed according to relaxed requirements. Also, if the UE is scheduled during the on-duration, this may trigger the inactivity timer to start. The measurements may be done according to existing requirements. If the UE, after a given amount of time or amount of gaps, has not successfully detected any cell on the indicated carrier, the UE may be allowed to or required to stop further measurements on the carrier. Such a stoppage may allow for more efficient scheduling and may increase UE throughput (TP). Also it may improve the UE power savings for example for the case where the UE is using a 2^{nd} receiver for performing the measurements.

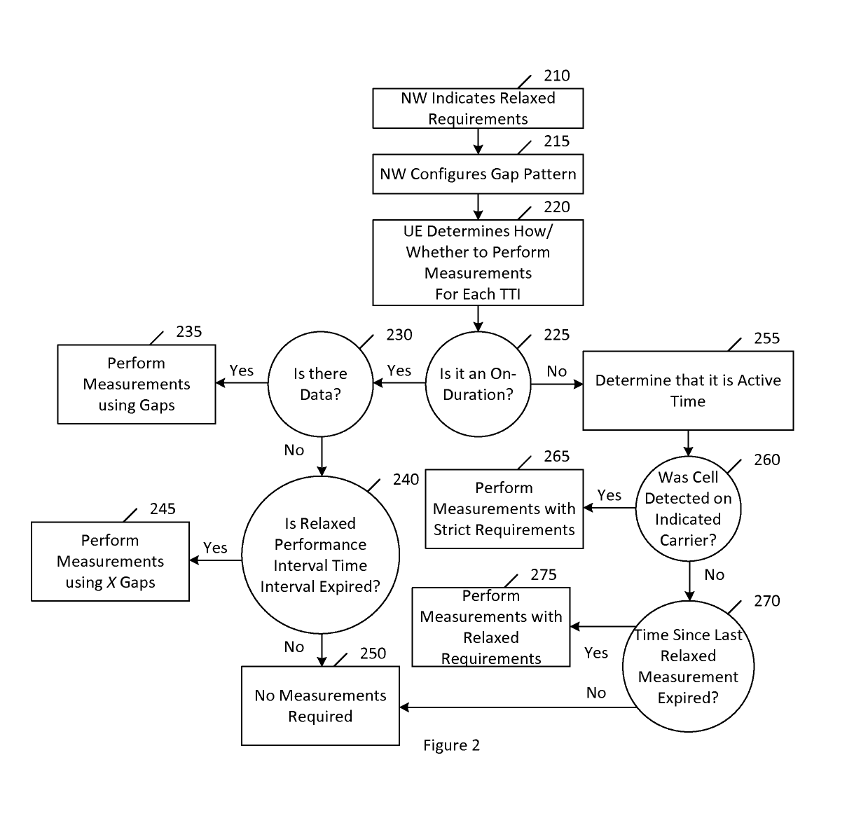

FIG. 2 illustrates a flow chart according to method according to certain embodiments. As shown in FIG. 2, the network (NW) can indicate relaxed requirements for a carrier at 210. Then, at 215, the network may configure a gap pattern for the UE if the UE needs gap-assisted measurement. This gap pattern could be one of the existing patterns but could also be new gap pattern. A UE that would not need gap-assisted measurement may not be configured with a gap pattern. For example, a UE with two receivers may not need, and consequently may not be configured with, a gap pattern. At 220, the UE can begin to determine how or whether to perform measurements, for every TTI, as described below.

First, the UE can determine whether it is an on-duration at 225. As a non-limiting example, on-duration is discussed in 3GPP TS 36.321, which is hereby incorporated herein by reference. As discussed in 3GPP TS 36.321, the UE may be configured with periodic wake up times, which can be referred to as on-duration periodicity. At each on-duration occasion, the UE can be awake and receive and monitor the PDCCH for possible allocation with respect to UL and/or DL. If the UE is not scheduled, the UE may stop monitoring the PDCCH and enter DRX, where it will not be receiving. If the UE is scheduled, the UE can start/re-start the inactivity timer. If the UE receives allocation(s) in UL and/or DL, the UE can start the inactivity timer and the UE can continue to monitor the PDCCH while the inactivity timer is active. More generally, whenever the UE is required to monitor the PDCCH, the UE can be in active time. That the UE is scheduled can refer to the fact that the UE has received an allocation in UL and/or DL via PDCCH.

If it is an on-duration, the UE can determine whether there is data at 230. The UE can determine that there is data to transmit if there is some data to be exchanged over the air interface between the UE and network. If there is data, the UE can, at 235, perform measurements—using the assigned gaps if needed. Otherwise, the UE can determine whether a relaxed performance interval time has expired, at 240. If the time interval has expired, then at 245, the UE can perform measurements—using X gaps if gaps are needed. Otherwise, at 250, no measurements are required.

If it is not an on-duration, then the UE can determine, at 255, whether it is an active time. The UE can then, at 260, determine whether a cell has been detected on an indicated carrier, namely a carrier with relaxed requirements. If so, the UE can, at 265, perform measurements according to strict requirements.

If the cell was not or has not been detected on an indicated carrier, then the UE can determine, at 270, whether the time since last relaxed measurement has expired. If so, then the UE can perform relaxed measurements at 275. If not, then the UE does not need to perform measurements, as indicated at 250.

The term Active Time here refers to current definition in 3GPP TS 36.133 and 36.321, in which the UE is regarded as being active, for example, in active time and actively in exchange with the network on some level.

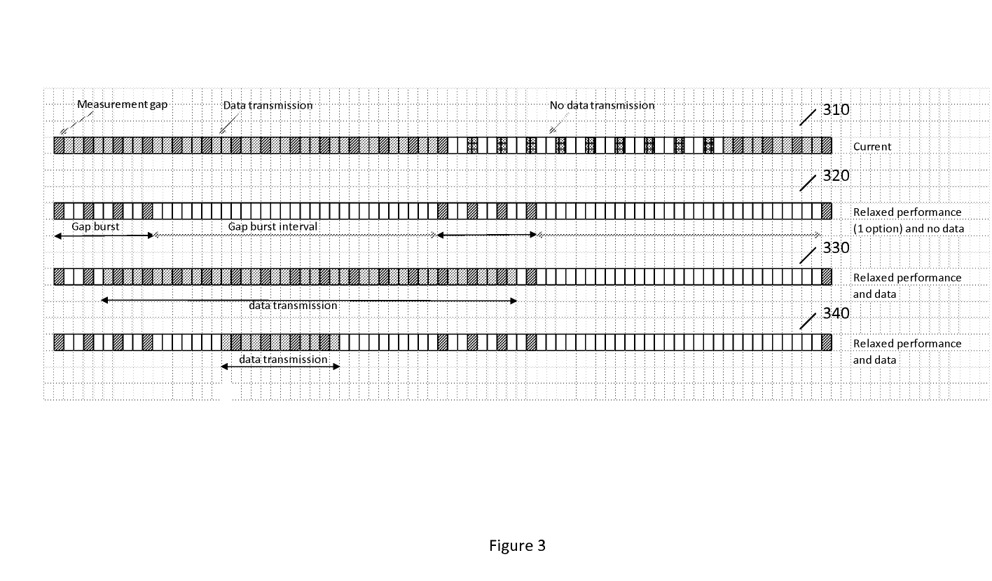

FIG. 3 illustrates gap usage according to certain embodiments. More particularly, FIG. 3 illustrates gaps assigned and used in case scheduled and not used when not scheduled and not used when no cell is detected and used when a cell is detected. The figure is illustrated using gaps but the same principle applies for when the UE does not need measurement gaps.

Thus, the principles shown in FIG. 3 can apply to a general case in which relaxed requirements are used when there is no data exchange ongoing. When there is data ongoing or according to what are sometimes referred to as triggers, the UE can perform measurements normally, not relaxed, but may stop again if nothing is detected. Some UEs may need gaps to perform the inter-frequency measurements, but not all UEs may require such gaps. For example, a UE with two receivers where one is not used may use the otherwise unused receiver to perform the inter-frequency measurements. In such a case, the UE may not need gaps. Nevertheless, for such a UE, the same principles discussed herein can apply.

For example, line 310 illustrates a current scheme in which there are measurement gaps during and between data transmission, with allocated but likely unused gaps during no data transmission. Line 320 illustrates relaxed requirements exemplified by a gap burst approach with bursts of gaps separated by a gap burst interval. In this line, there is no data. Line 330 illustrates a situation in which the exemplified relaxed requirements are applied and where there is data transmission. As seen some gaps employed, particularly while the data is being transmitted. Line 340 illustrates a situation in which the data is actively transmitted for only a short duration corresponding for example between otherwise two set of measurements according to relaxed requirements but measurement set is performed due to data transmission like line 330.

Certain embodiments may have certain benefits or advantages. For example, in certain embodiments, a user equipment may find offloading opportunities faster when the user equipment is active, while still saving power when using discontinuous reception.

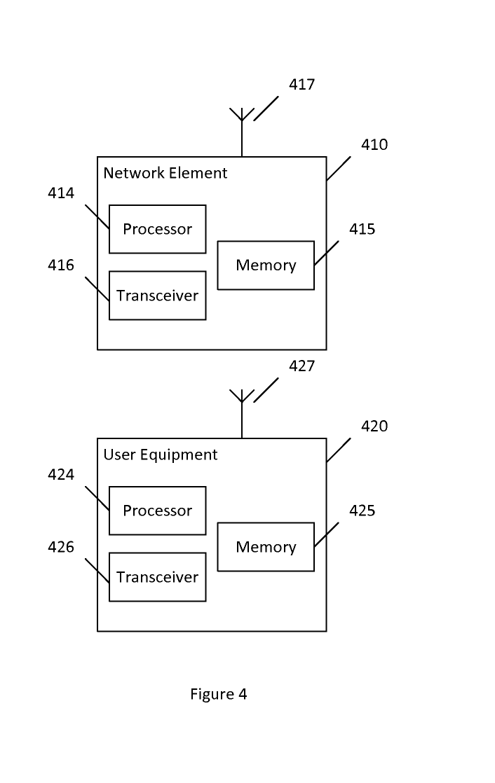

FIG. 4 illustrates a system according to certain embodiments. It should be understood that each block of the flowchart of FIG. 1 or 2 and any combination thereof may be implemented by various means or their combinations, such as hardware, software, firmware, one or more processors and/or circuitry. In one embodiment, a system may include several devices, such as, for example, network element 410 and user equipment (UE) or user device 420. The system may include more than one UE 420 and more than one network element 410, although only one of each is shown for the purposes of illustration. A network element can be an access point, a base station, an eNode B (eNB), server, host or any of the other network elements discussed herein. Each of these devices may include at least one processor or control unit or module, respectively indicated as 414 and 424. At least one memory may be provided in each device, and indicated as 415 and 425, respectively. The memory may include computer program instructions or computer code contained therein. One or more transceiver 416 and 426 may be provided, and each device may also include an antenna, respectively illustrated as 417 and 427. Although only one antenna each is shown, many antennas and multiple antenna elements may be provided to each of the devices. Other configurations of these devices, for example, may be provided. For example, network element 410 and UE 420 may be additionally configured for wired communication, in addition to wireless communication, and in such a case antennas 417 and 427 may illustrate any form of communication hardware, without being limited to merely an antenna. Likewise, some network elements 410 may be solely configured for wired communication, and in such cases antenna 417 may illustrate any form of wired communication hardware, such as a network interface card.

Transceivers 416 and 426 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network element deliver local content. One or more functionalities may also be implemented as virtual application(s) in software that can run on a server.

A user device or user equipment 420 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof.

In an exemplary embodiment, an apparatus, such as a node or user device, may include means for carrying out embodiments described above in relation to FIG. 1 or 2.

Processors 414 and 424 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 415 and 425 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 410 and/or UE 420, to perform any of the processes described above (see, for example, FIGS. 1 and 2). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 4 illustrates a system including a network element 410 and a UE 420, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node. The UE 420 may likewise be provided with a variety of configurations for communication other than communication network element 410. For example, the UE 420 may be configured for device-to-device communication.

The above examples have used gaps and gap bursts as an example, but certain embodiments are not limited to this example. In certain embodiments, the UE may not need gap assistance for performing the measurement. For example, the UE may have two receivers.

Likewise, gap burst is an example only. For example, the UE can have a given set of bursts and can perform measurements for a given time. In general this burst—or measurement time—can also be given just as a time—for example X ms. This may be used, for example, in a non-gap-assisted case.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1.-32. (canceled)

33. A method, comprising:
determining, by a user equipment, whether a user equipment is in an active data transfer; and
using relaxed performance measurement requirements when the user equipment is determined not to be in an active data transfer.

34. The method of claim 33, where the relaxed requirements are applied with respect to a plurality of gap bursts and/or set of measurements.

35. The method of claim 33, wherein relaxed requirements are applied for a particular cell or carrier.

36. The method of claim 33, further comprising:
determining that the user equipment is in active data transfer when at least one trigger occurs, selected from
an inactivity timer is running;
user equipment uplink buffers are not empty or a non-empty buffer status report is or has been sent to network;
short discontinuous reception is active;
the user equipment has powerPrefIndication set to normal;
the UE has sent a scheduling or UL resource request in uplink or received a downlink assignment;
the user equipment has on-going or pending re-transmissions; or
a user equipment radio resource control release timer not expired.

37. The method of claim 34, further comprising:
starting a gap burst of the plurality of gap bursts or measurement set when a discontinuous reception inactivity timer is started or when a buffer status report or scheduling request is triggered.

38. The method of claim 37, wherein the gap burst is an additional gap burst or shifts timing of further gap bursts.

39. The method of claim 33, wherein the relaxed requirements are used only when the user equipment is determined not to be in active data transfer.

40. A method, comprising:
indicating, by a network element, relaxed performance measurement requirements with respect to a plurality of gap bursts and/or set of measurements; and
configuring the plurality of gap bursts.

41. The method of claim 40, wherein the configuring the plurality of gap bursts comprises configuring a pattern of the gap bursts.

42. The method of claim 40, where indicating the relaxed requirements comprises indicating the relaxed requirements for a particular cell or carrier.

43. An apparatus, comprising:
at least one processor; and
at least one memory including computer program code,
wherein the at least one memory and the computer program code can be configured to, with at least one processor, cause the apparatuses at least to
determine whether a user equipment is in active data transfer; and
use a relaxed performance measurement requirements when the user equipment is determined not to be in active data transfer.

44. An apparatus of claim 43, wherein the relaxed requirements are defined with respect to a plurality of gap bursts and/or set of measurements.

45. An apparatus of claim 43, wherein the relaxed requirements are applied for a particular cell or carrier.

46. The apparatus of claim 43, wherein the at least one memory and the computer program code can be configured to, with at least one processor, cause the apparatuses at least to determine that the user equipment is in active data transfer when at least one trigger occurs, selected from
an inactivity timer is running;
user equipment uplink buffers are not empty or a non-empty buffer status report is or has been sent to network;
short discontinuous reception is active;
the user equipment has powerPrefIndication set to normal;
the UE has sent a scheduling or UL resource request in uplink or received a downlink assignment;
the user equipment has on-going or pending re-transmissions; or
a user equipment radio resource control release timer not expired.

47. The apparatus of claim 44, wherein the at least one memory and the computer program code can be configured to, with at least one processor, cause the apparatuses at least to start a gap burst of the plurality of gap bursts or measurement set when a discontinuous reception inactivity timer is started or when a buffer status report or scheduling request is triggered.

48. The apparatus of claim 47, wherein the gap burst is an additional gap burst or shifts timing of further gap bursts.

49. The apparatus of claim 43, wherein the relaxed requirements are used only when the user equipment is determined not to be in active data transfer.

50. An apparatus, comprising:
at least one processor; and
at least one memory including computer program code,
wherein the at least one memory and the computer program code can be configured to, with at least one processor, cause the apparatuses at least to
indicate relaxed performance requirements with respect to a plurality of gap bursts or set of measurements; and
configure the plurality of gap bursts.

51. The apparatus of claim 50, wherein the at least one memory and the computer program code can be configured to, with at least one processor, cause the apparatuses at least to configure a pattern of the gap bursts.

52. The apparatus of claim 50, wherein the at least one memory and the computer program code can be configured to, with at least one processor, cause the apparatuses at least to indicate the relaxed performance requirements for a particular cell or carrier.

53. A non-transitory computer readable medium encoded with instructions that, when executed in hardware, perform a process, the processing comprising the method according to claim 33.
